(19) United States
(12) Patent Application Publication
(10) Pub. No.: US 2017/0285604 A1
(43) Pub. Date: Oct. 5, 2017

(54) PROGRAMMABLE LOGIC CONTROLLER

(71) Applicant: MESHARI J.S.A. AL-JANDAL, SAFAT (KW)

(72) Inventor: MESHARI J.S.A. AL-JANDAL, SAFAT (KW)

(21) Appl. No.: 15/084,420

(22) Filed: Mar. 29, 2016

(51) Int. Cl. G05B 19/05; G06F 1/28; G06F 13/42

(52) U.S. Cl. CPC G05B 19/054; G06F 13/4282; G06F 1/28; G05B 2219/15078

(57) ABSTRACT

The programmable logic controller is a PLC-like controller having an elongate box-shaped main unit, a truncated, box-shaped expansion module, and a cable that couples the main unit to the expansion module. The main unit is a CPU adapter prepared specially to receive an open source microcontroller board, which carries out the instructions of the control process. It performs the basic arithmetical, logical, and input/output operations of the process, and communicates with outside devices. The expansion module expands the unit with a programmable logic controller programmed using open source software according to the process and requirements with a multiple arrangements of digital and analog inputs and outputs, as well as Special Function Modules (GSM, Ethernet, MPI, Thermocouple, etc.).

### BACKGROUND OF THE INVENTION

### 1. Field of the Invention

The present invention relates generally to expandable microcontroller systems, and particularly to a programmable logic controller (PLC) expansion board for a microcontroller-based system, the PLC being programmable using open source software.

### 2. Description of the Related Art

Programmable logic controllers (PLC) are well known industrial-level logic controllers due to their durability in counteracting the temperature ranges, immunity to electrical noise and resistance to vibrations and impacts. However, the use of PLCs in industrial applications has made PLC systems very expensive, both to buy and repair. Moreover, PLC manufacturers limit the users to use the development and programming environment provided with their PLC units. This results in constraining the user's ability to program special applications.

Thus, a programmable logic controller solving the aforementioned problems is desired.

### SUMMARY OF THE INVENTION

The programmable logic controller (PLC) provides a new generation of PLC-like unit that can be assembled by using universal embedded systems to serve as a CPU. This allows the user to choose the preferred type of the embedded system as a CPU for the unit.

The present PLC would allow wider use for PLC-like units for industrial and non-industrial applications in an affordable and feasible way for everyone. The unit can be programmed by various open source software and can expand into multiple types and number of inputs and outputs.

These and other features of the present invention will become readily apparent upon further review of the following specification and drawings.

### BRIEF DESCRIPTION OF THE DRAWINGS

FIG. 1 is a perspective view of a programmable logic controller (PLC) according to the present invention, showing the main and expansion PLC adapter modules.

FIG. 2 is a perspective view of the main module of the programmable logic controller (PLC) of FIG. 1 with the top of the housing removed, showing the embedded microcontroller system.

FIG. 3 is an exploded, perspective view of the main PLC adapter module of the programmable logic controller (PLC) of FIG. 1.

FIG. 4 is a block diagram of the programmable logic controller (PLC) of FIG. 1, showing the main and expansion PLC adapter modules connected together.

FIG. 5A is a partial schematic diagram of the main PLC adapter module of the programmable logic controller (PLC) of FIG. 1, showing the pin identifications for the jumper blocks.

FIG. 5B is a partial schematic diagram of the main PLC adapter module of the programmable logic controller (PLC) of FIG. 1, showing the input and output optoisolators.

FIG. 6A is a partial schematic diagram of the expansion PLC adapter module of the programmable logic controller (PLC) of FIG. 1, showing the pin identifications for the jumper blocks.

FIG. 6B is a partial schematic diagram of the expansion PLC adapter module of the programmable logic controller (PLC) of FIG. 1, showing indicator LEDs.

Similar reference characters denote corresponding features consistently throughout the attached drawings.

### DETAILED DESCRIPTION OF THE PREFERRED EMBODIMENTS

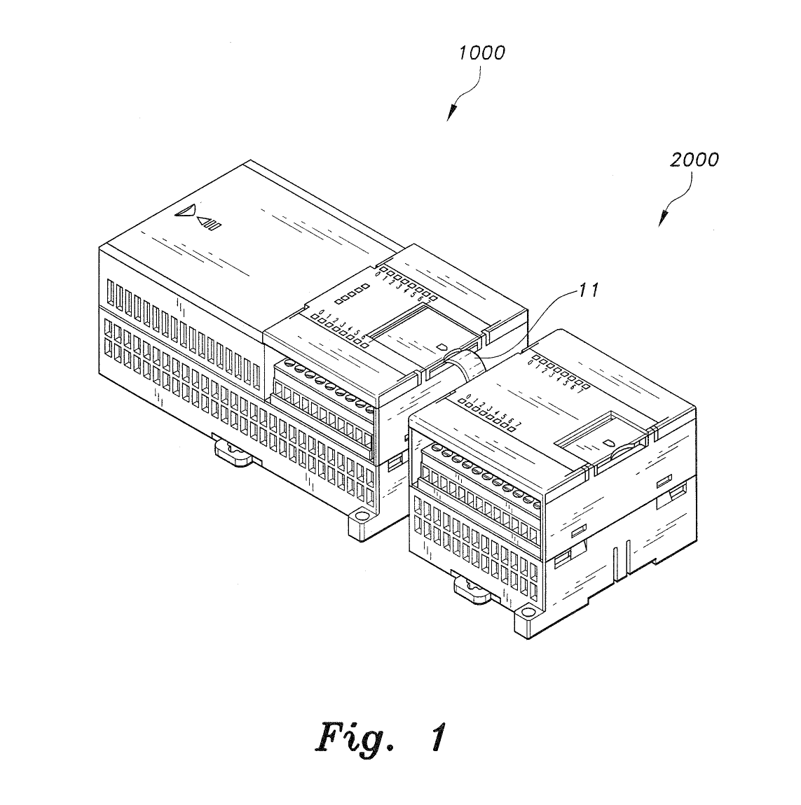

As shown in FIG. 1, the programmable logic controller is a PLC-like unit comprising an elongate, box-shaped main unit 1000, a truncated, box-shaped expansion module 2000, and a cable 11 that couples the main unit 1000 to the expansion module 2000. The main unit 1000 is a CPU adapter prepared specially to receive Arduino or any embedded microcontroller board or system, which may have a USB port and which carries out the instructions of the control process. It performs the basic arithmetical, logical, and input/output operations of the process, and communicates with outside devices. The expansion module 2000 expands the unit 1000 according to the process and requirements with multiple arrangements of digital and analog inputs and outputs, as well as Special Function Modules (GSM, Ethernet, MPI, Thermocouple, etc.). The configuration allows for an embedded system module, such as Raspberry Pi® (Raspberry Pi is a registered trademark of the Raspberry Pi Foundation, United Kingdom), Arduino® (Raspberry Pi is a registered trademark of the Arduino, LLC of Somerville, Mass.), Galileo (or Intel Galileo, another Arduino microcontroller board), etc., to be utilized in an affordable and flexible way. Unlike PLC units, which are limited to be programmed using the manufacturer's provided software, the present programmable logic controller would utilize open source software to program the functions and overcome this limitation of existing PLC units. These features allow users to expand the capabilities of their codes and optimize their codes.

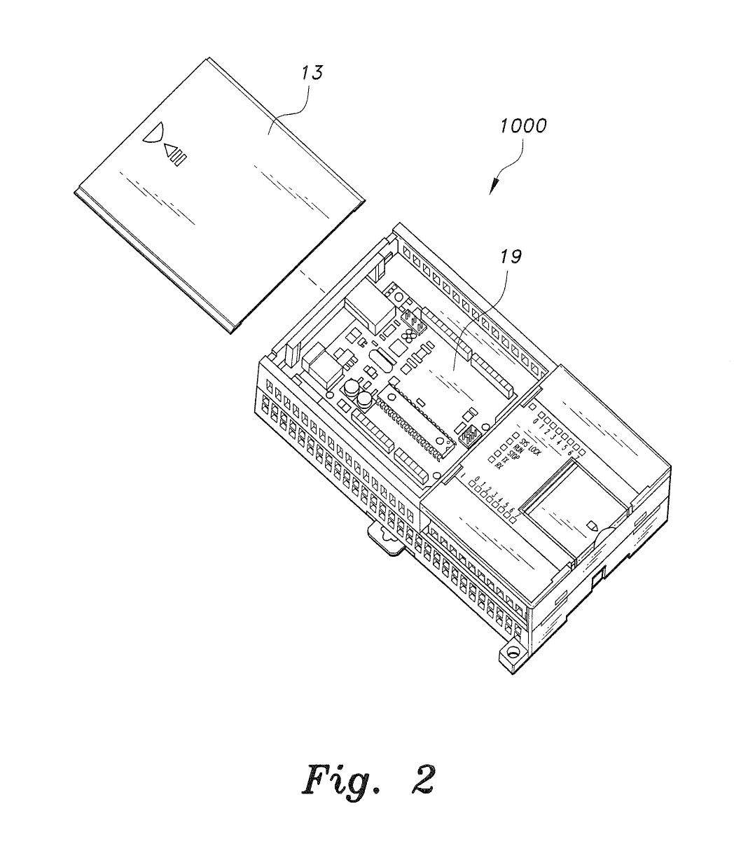

As shown in FIG. 2, the embedded system module 19 (microcontroller board) is disposed inside the main unit 1000, the embedded system module being covered by removable sliding cover 13 that slidably attaches to the top chassis portion of the main unit 1000. While each PLC unit has its own CPU, the present programmable logic controller would allow the user to select the preferred embedded system to act as the CPU, thus allowing the user to select the embedded system unit with the required functionalities, as well as the number of inputs and output ports. Furthermore, the selection of different embedded systems enhances the scalability of the unit to allow a wider spectrum of voltage ranges, varying from low voltages of 0 volts or a higher voltage of 24 volts. The prototype of the present programmable logic controller exists in three different sizes to handle the current sizes of the existing embedded system units. Having small, medium and large sizes of the present programmable logic controller allows the user to select the size that is more suitable for his/her application financially, as well as from the assembly point of view. Moreover, the difference in sizes would enhance the scalability of the system to handle multiple inputs and multiple outputs, overcoming the shields for the modules, and allows connecting various types of modules, such as digital, analog and special functions, in series configuration.

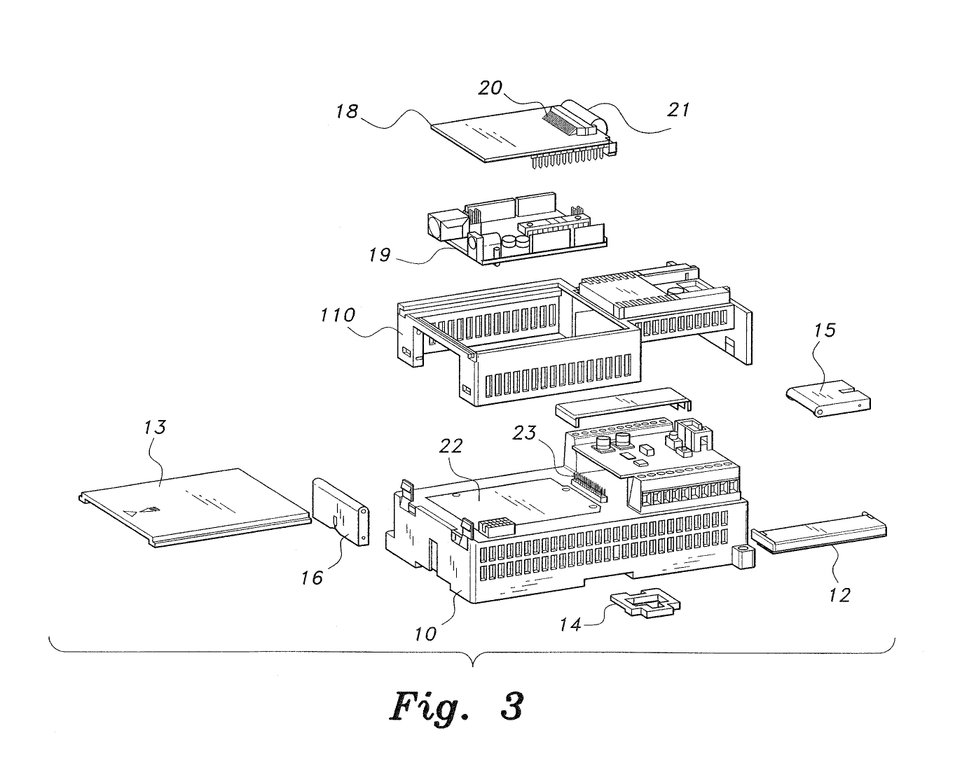

FIG. 3 illustrates the physical layout of the present programmable logic controller. The main unit 1000 is a PLC-like unit that uses an embedded system module, such as Raspberry Pi, Arduino, Galileo, or the like. The expansion module 2000 is designed to expand the unit according to the process and requirements with multiple arrangements of digital and analog inputs and outputs, as well as Special Function Modules (GSM, Ethernet, MPI, Thermocouple, and the like). The base 10 is a base unit that holds a PCB (printed circuit board) card and all electronic parts of the programmable logic controller. The protective housing 110 is designed to cover and protect the top side of the present programmable logic controller. A first movable cover 12 is removably attachable to cover and protect the tell iinals. The sliding cover 13 is designed with an L groove to slidably attach to the unit housing 110, thereby protecting the embedded circuit 19 when the sliding cover 13 is attached. The rail lock 14 is a member disposed on the rail to affix the unit on the rail of the panel. A second movable cover 15 is removably attachable to the unit over the ribbon plug to protect the ribbon plug from damage. A third movable cover 16 is removably attachable to the unit over the embedded circuit ports to protect the embedded circuit ports. The embedded system connector 18 is a connector designed to connect an embedded system 19 with the present programmable logic controller via a ribbon cable 21 to transfer data. A first ribbon cable connector 20 is a female connector on the unit, to which the ribbon cable 21 attaches. The embedded system base 22 is designed to allow attachment of the embedded system to the unit. A second ribbon cable connector 23 is disposed on the base 10.

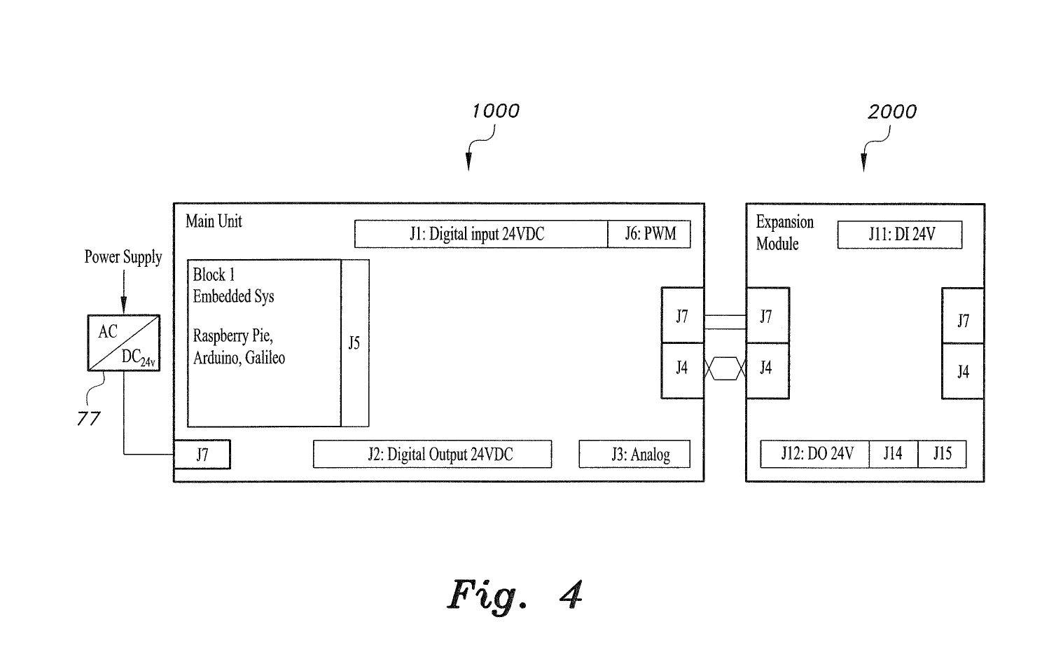

The block diagram of FIG. 4 represents the present programmable logic controller's integrated system terminal and illustrates how it is connected with the expansion module. The expansion modules can expand into multiple types and number of inputs and outputs, as well as special function expansion modules. As shown in FIG. 4, the power supply 77 provides 24-volt DC power to the main unit 1000 and expansion unit 2000 via the power connectors J7. Table 1 details the possible connectivity from the main unit 1000. Table 2 details the possible connectivity on the expansion module 2000.

TABLE 1
Main Unit Possible Connectivity

| Jumper | Function |
|---|---|
| J1: | 5 × Digital input 24 VDC |
| J2: | 5 × Digital output 24 VDC |
| J3: | 6 × Analog input (0-5 V), 10 bit resolution (0-1023) |
| J4: | Serial port (Tx, Rx) to communicate with expansion modules |
| J5: | Pin Terminals where the ribbon cable connector (Female) |
| | communicate the data from embedded system to the present PLC |
| J6: | 2 × Bi-directional pulse width modulations (PWM), 0-5 v |
| J7: | Power supply 24 VDC |

TABLE 2
Expansion Module Connectivity

| Jumper | Function |
|---|---|
| J11: | 5 × Digital input 24 VDC |
| J12: | 5 × Digital output 24 VDC |
| J14: | I²C Bus - SDA(data line) and SCL(clock line) |
| J15: | 4 × Bi-directional digital input/output (0-5 v) |

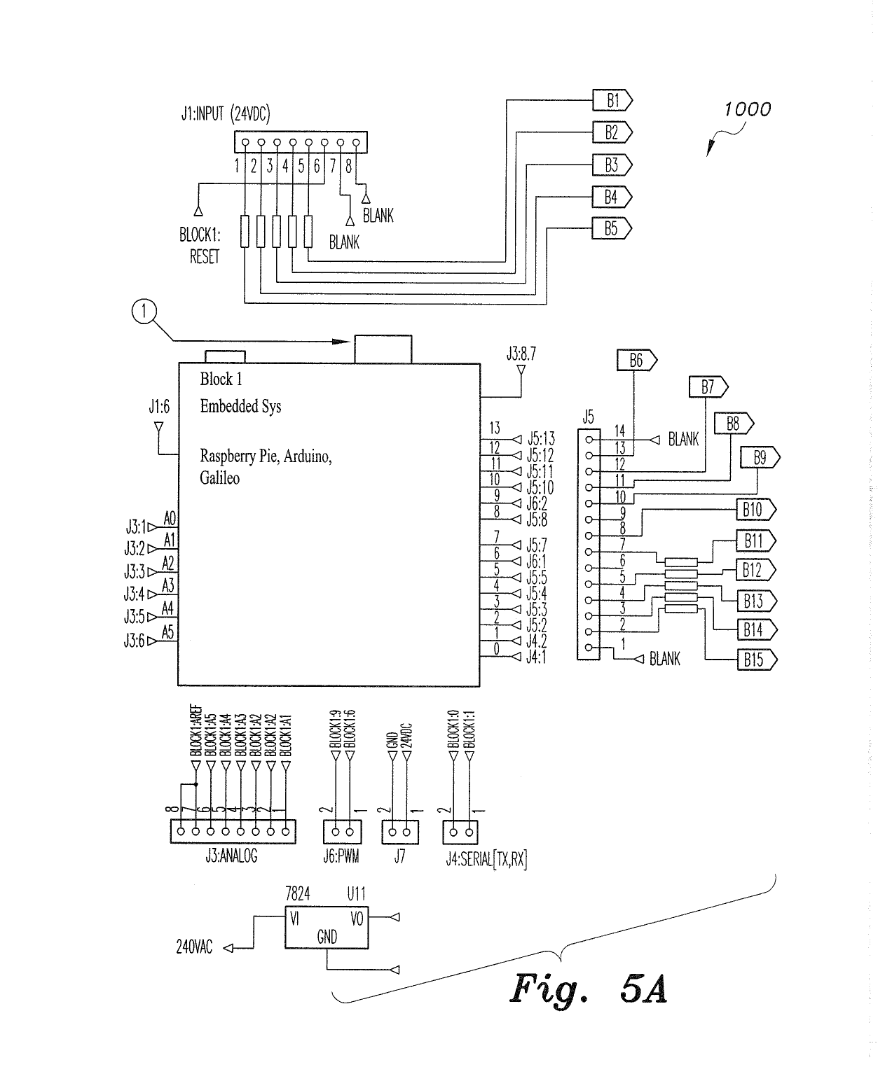

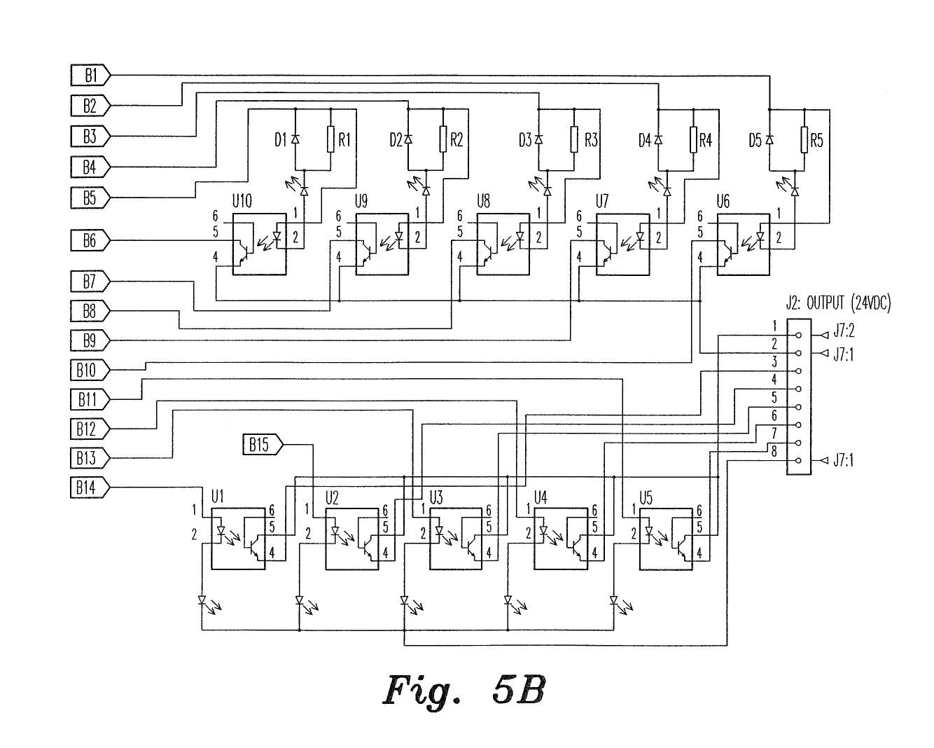

The Main unit 1000 houses the embedded system 19, whose ports are connected to the unit through the J5 terminal using the ribbon cable 21 connected to the ribbon cable connector 20 disposed on the embedded system connector plate 18. The digital input terminal J1 (shown in FIG. 4) has 24, VDC which can be stepped down into a predetermined DC voltage, e.g., 5 VDC, using the optocoupler-NPN types U6-U10 (shown in FIG. 5B, the main processor being shown in FIG. 5A). While ON, the output tenninal J2 transmits 24 VDC after stepping up the 5 VDC via optocoupler-NPN U1-U5 (shown in FIG. 5B). The LEDs shown in the input and output circuits are used for giving the user an indication that there is a voltage at the optocouplers, which helps in troubleshooting and fault tolerance.

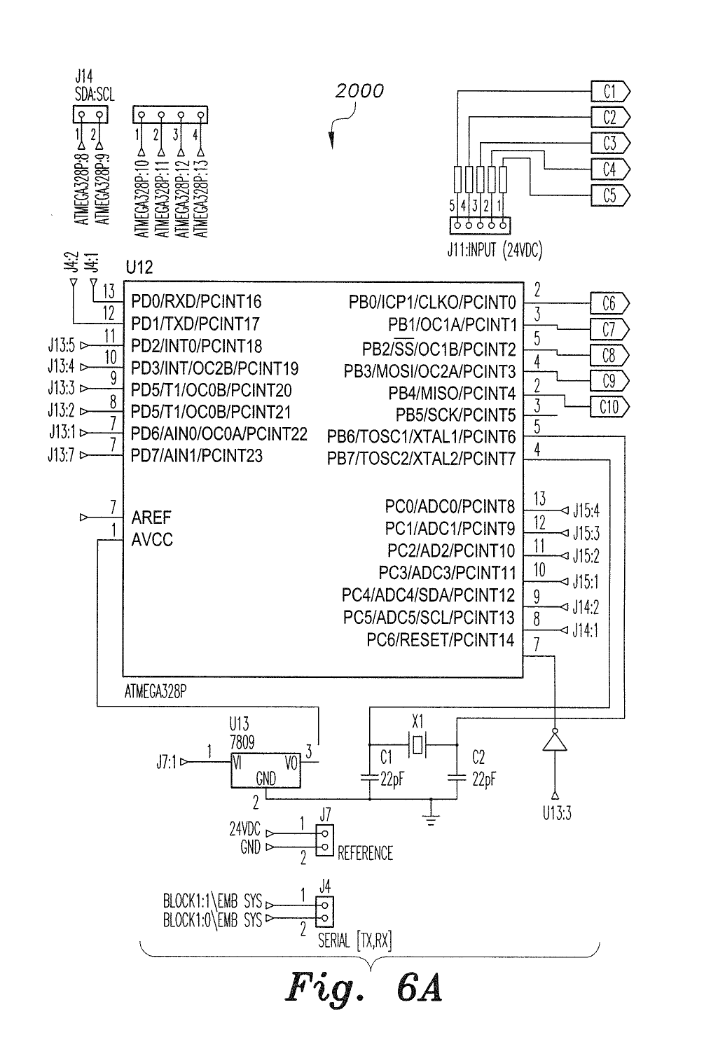

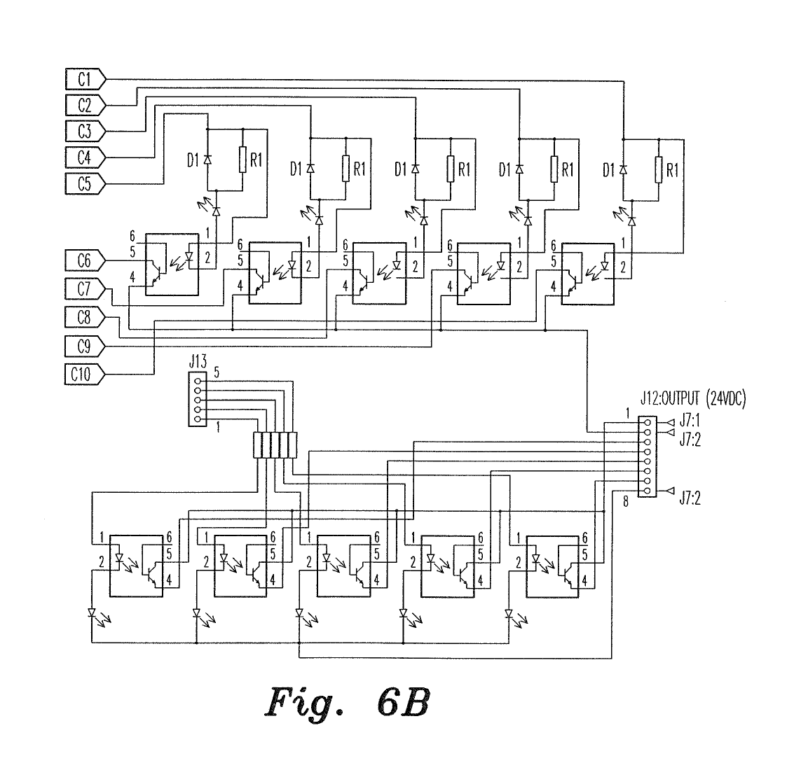

The expansion module 2000 is connected to the main unit 1000 using a serial port (Tₓ, Rₓ) that is shown as J4 in FIG. 4. The expansion module reads the inputs from J11 and processes it using the Atmel microcontroller ATMEGA328P in U12 (shown in FIG. 6A, the opto-isolators being shown in FIG. 6B) and then sends the updates to the embedded system of the main unit 1000 using the serial port J4. For the outputs J12, the instructions are received from the embedded system of the main unit 1000 and the microcontroller activates the required output.

The present programmable logic controller is based on a simple concept that the more you know, the more likely you will control your machine or any process that has a lot of inputs and outputs by introducing an adapter with an expansion module, such as expansion module 2000. Moreover, the adapter will promote the Arduino to industrial level with multiple arrangements of digital and analog inputs and outputs module, extended temperature ranges, immunity to electrical noise, and resistance to vibration and impact.

Basically, the adapter doesn't include CPU (Central Process Unit) because it depends mainly on the Arduino or any embedded system with configuring the Dip Switch according to the type of the electronic card (Arduino/Embedded System) for synchronization. The Adapter can be expanded by adding expansion units according to the process and requirements by using the back plane bus for communication between the adapter and the expansion modules.

The configuration as well as the programming will be done by software integrated with the system using ladder programming/Function Block/C++.

The software embodies a very simple idea that any type of Arduino microcontroller board or embedded system (open source microcontroller board) can be plugged into the adapter virtually. The user can program the unit via either a ladder block or a function block.

It is to be understood that the present invention is not limited to the embodiments described above, but encompasses any and all embodiments within the scope of the following claims.

1. A programmable logic controller, comprising:
a main PLC module, wherein the main PLC module includes:)
a 24-VDC digital input terminal, wherein the digital input terminal includes a plurality of step-down optocouplers for stepping the 24 VDC down to a predetermined DC voltage;
ii) a 24-VDC digital output terminal;
iii an analog input terminal;
iv) a serial (Tₓ, Rₓ) port for communication with an expansion module;
v) a bi-directional pulse width modulation (PWM) terminal; and
vi) a 24-VDC power tenninal;
a first expansion PLC module, the first expansion PLC module consists of:
a) a first expansion PLC processor board connector and a first expansion PLC processor board removably connectable to the first expansion PLC processor board connector to provide an embedded circuit of the first expansion PLC module, the embedded circuit includes a plurality of ports;
b) a 24-VDC digital input terminal, the digital input terminal includes a plurality of step-down optocouplers for stepping the 24 VDC down to a predetermined DC voltage;
c) a 24-VDC digital output terminal;
d) an I2C Bus including a SDA(data line) and a SCL(clock line); a bi-directional digital input/output; and
an electrical cable having a removable connection between the main PLC module and the first expansion PLC module for operable communication between the main PLC module and the first expansion PLC module.

2. The programmable logic controller according to claim 1, further comprising a connector disposed on the first expansion PLC module, the connector having an electrical configuration supporting operable communication between the main PLC module, the first expansion PLC module, and a second expansion PLC module when a cable is connected to the connector of the first PLC module.

3. The programmable logic controller according to claim 1, wherein the main PLC module further comprises a main PLC processor board connector adapted for removably connecting a main PLC processor board to the main PLC processor board connector to provide an embedded circuit of the main PLC module.

4-16. (canceled)
